(19) United States
(12) Patent Application Publication
(10) Pub. No.: US 2003/0172598 A1
(43) Pub. Date: Sep. 18, 2003

(54) Passive optical control system for boomed apparatus

(76) Inventor: Mark Greer, St. Joseph, MO (US)

Correspondence Address: THOMAS B. LUEBBERING, HOVEY WILLIAMS LLP, Suite 400, 2405 Grand, Kansas City, MO, 64108, US

(21) Appl. No.: 10/096,264

(22) Filed: Mar. 12, 2002

(51) Int. Cl. E04H 12/34; B66C 23/06; B66C 23/62

(52) U.S. Cl. 52/116

(57) ABSTRACT

A passive optical control system for an aerial device comprising an optical signal source, an electrically passive modulator coupled with an electrically passive input mechanism located in or on an electrically isolated work station, and an optical receiver, wherein the source transmits an optical signal across a dielectric gap to the modulator which modulates, attenuates, or otherwise changes the optical signal to produce a changed optical signal corresponding to a control input provided by the input mechanism and sends the changed optical signal back across the dielectric gap to the receiver whereafter the changed optical signal is converted to a proportional electrical signal, thereby safely and efficiently maintaining the electrical isolation of the work station.

### BACKGROUND OF THE INVENTION

1. FIELD OF THE INVENTION

The present invention relates to control systems for controlling operation and functionality of boomed apparatuses. More particularly, the present invention concerns a passive optical control system for a boomed apparatus, such as, for example, an aerial lift device, digger derrick, or crane, comprising an optical signal source, a passive modulator coupled with a passive input mechanism located in or on an electrically isolated work station, and an optical receiver, wherein the source transmits an optical signal across a dielectric gap to the modulator which modulates, attenuates, or otherwise changes the optical signal in an electrically passive manner to produce a changed optical signal corresponding to a control input provided by the input mechanism and sends the changed optical signal back across the dielectric gap to the receiver whereafter the changed optical signal is converted to a proportional electrical signal, thereby safely and efficiently maintaining the electrical isolation of the work station.

2. DESCRIPTION OF THE PRIOR ART

It is often desirable, particularly among the electric and communication utility industries, to provide a boomed apparatus, such as, for example, an aerial lift device, digger derrick, or crane, operable to facilitate work at or from an elevated position, such as, for example, high on an electric or telephone utility pole or on a wall of a building. Such a boomed apparatus is embodied in, for example, a common bucket truck comprising a work station; a hydraulically-movable boom; a plurality of electro-hydraulic control valves, actuators, pulsars, or other similar devices; and a vehicular platform. The work station is operable to lift or otherwise carry at least one worker to the elevated work site, and is coupled with the boom at or near a distal end thereof. A control station is located in or on the work station to allow the elevated worker to control movement of the boom. The boom is hydraulically movable so as to elevate and otherwise position the work station where desired, and is coupled with the vehicular platform at or near a base end of the boom which is opposite the distal end. The control valves are operable to implement movement of the boom and positioning of the workstation in accordance with control signals provided by the worker via the control station. Some or all of the control valves are typically located at or near the base end of the boom. The vehicular platform is motorized and wheeled or otherwise adapted to quickly and efficiently travel to and from the work site. The vehicular platform will either be in direct contact with an electrical ground, such as, for example, the Earth, or imminently at risk of direct or indirect contact therewith.

Thus, it will be appreciated that control signals provided by the worker via the control station located in or on the work station must travel from the distal end to the base end of the boom in order to implement the desired movement. It will also be appreciated, however, that the work station and the worker therein will frequently be positioned near or otherwise exposed to dangerously charged electrical lines or devices, thereby exposing the worker to a risk of electrocution. It is therefore desirable to maintain the work station in a state of electrical isolation relative to the vehicular platform.

Various schemes exist in the prior art for establishing, maintaining, and periodically testing such electrical isolation. One common partial solution is to construct at least a portion of the boom from an electrically non-conductive, or dielectric, material. The boom is maintained and periodically tested, using standards such as, for example, ANSI 92.2, to ensure the continued dielectric integrity of the non-conductive portion. Unfortunately, a transmission path or link must exist for the control signals to travel from the control station to the control valves. It is well-known and common to use a fluidic connection of hydraulic fluid moving in conduits extending between the control station and the base of the boom to transmit the control signals. Unfortunately, these hydraulic connections, whether full-pressure or pilot-activated, suffer from a large number of drawbacks and disadvantages, including, for example, a high potential for fluid leakage along the length of the conduits, wherein such leakage may attract dirt and compromise the electrical isolation. Furthermore, the fluid is flammable, so leaks present substantial fire hazards. Additionally, because the input mechanism must be directly connected with the fluid conduits, positioning of the input mechanism is often not primarily determined by convenience or safety, and, in fact, the input mechanism is typically located outside of a protective envelope provided by the work station, thereby potentially necessitating dangerous exposure of the worker. Additionally, such fluidic transmission mechanisms are generally complex, heavy, large, and costly.

Other mechanisms used for transmitting control signals to the control valves include, for example, mechanical push rods or torsion rods made of a non-conducting material; wireless radio-frequency transmitters and receivers; and active electro-optical transmitters and receivers, whether wireless or hardwired using a dielectric optical cable. In the case of the latter two mechanisms, control inputs at the work station are converted to a modulated electronic signal and then transmitted across the dielectric gap to a receiver that drives the control valves. It will be appreciated, however, that these mechanisms are also undesirably complex, heavy, large, and costly. Weight and size are of special concern, particularly along the boom and at the work station, as the boom may need to be structurally enhanced to physically support or otherwise allow for such extra weight or size. Furthermore, those mechanisms that include active components on the otherwise electrically isolated side of the dielectric gap require heavy batteries or other power supplies, undesirably increase risks of damaging electrical discharge and electrocution, and are generally inconvenient to use and maintain.

Due to the aforementioned problems and disadvantages in the prior art, a need exists for an improved control system for aerial devices.

### SUMMARY OF THE INVENTION

The present invention overcomes the above-identified and other problems and disadvantages in the prior art by providing a distinct advance in the art of control systems for boomed apparatuses. More particularly, the present invention provides a passive optical control system for a boomed apparatus which safely and efficiently maintains an electrical isolation of a work station portion of the boomed apparatus, thereby substantially protecting against damage and electrocution due to electrical discharge. The boomed apparatus may be, for example, any substantially conventional aerial lift device, digger derrick, or crane, including the bucket truck described above as comprising the work station, a boom, a plurality of control valves, and a vehicular platform.

In a preferred embodiment, the control system broadly comprises an optical signal source; an electrically passive modulator coupled with an electrically passive input mechanism located in or on the electrically isolated work station; and an optical signal receiver. The source is a transmitter operable to generate an optical signal for-transmission via the first path across an electrically isolating or dielectric gap to the modulator at the work station.

The first path is an optical waveguide constructed of an electrically non-conducting or dielectric material, such as, for example, fiberoptic cable, that provides a secure low-loss transmission medium for optical signals. Because the first path is constructed of a dielectric material, it can span the dielectric gap without compromising the electrical isolation of the work station.

The modulator is operable to passively modulate, attenuate, or otherwise change the optical signal to produce a changed optical signal corresponding to a control input provided via the input mechanism by a worker at the work station. Preferably, both the modulator and the input mechanism are electrically passive devices, meaning that there are, for example, no electrical contacts, circuit boards, electronic components, copper conductors, or power supplies associated with them. Thus, all components located on the electrically isolated side of the dielectric gap may be constructed entirely of dielectric material, thereby further protecting against dangerous electrical discharges.

The second path is operable to transmit the changed optical signal from the modulator back across the dielectric gap to the receiver. The second path is otherwise substantially similar or identical to the first path.

The receiver is operable to receive the changed optical signal for implementation. Preferably, the receiver or a circuit associated therewith is also operable to convert the changed optical signal to a proportional electrical signal for actuating the control valves. This proportional electrical signal may be amplified and used directly, or may be input to a conventional control system, as desired.

It will be appreciated that the control system of the present invention provides for substantial advantages over the prior art, including, for example, elimination of the overall complexity, weight, space-requirements, and electrical conductivity associated with using hydraulic valves, hoses, and fluid to transmit control signals from the work station down the boom. Furthermore, the control system overcomes much of the mechanical complexity, cost, weight, and space required to implement and physically and operationally support an upper control system at the distal end of the boom. Additionally, the control system is not susceptible to electromagnetic interference, such as may be encountered when working in close proximity to highly charged electrical lines, transformers, or other similar devices.

These and other important aspects of the present invention are more fully described in the section entitled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a plan view of a common bucket truck on which is installed a preferred first embodiment of the control system of the present invention;

FIG. 2 is a block diagram of a preferred embodiment of the control system of the present invention;

FIG. 3 is a flowchart of a progression of preferred operational steps implemented by the control system of FIG. 2; and

FIG. 4 is a plan view of a common digger derrick on which is installed a preferred second embodiment of the control system of the present invention.

### DETAILED DESCRIPTION OF A PREFERRED EMBODIMENT

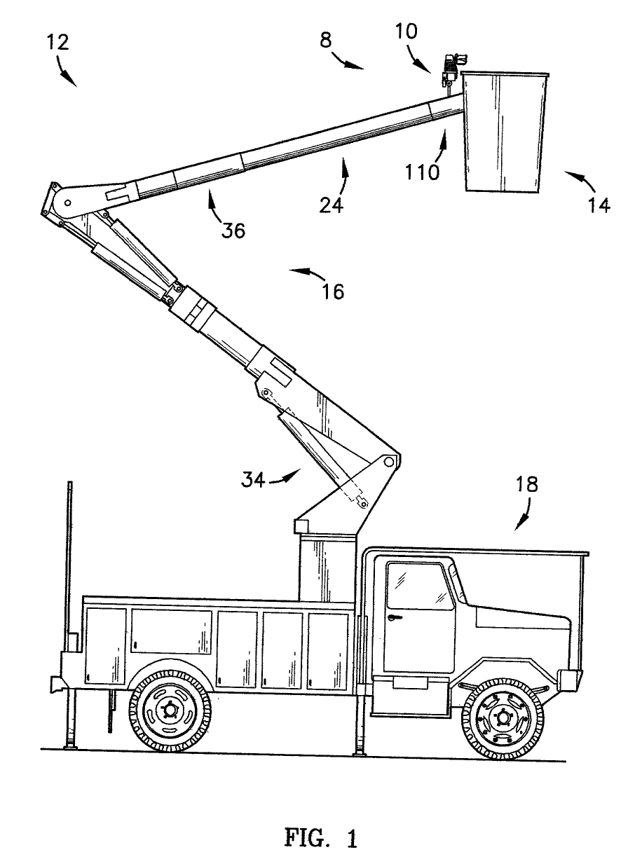

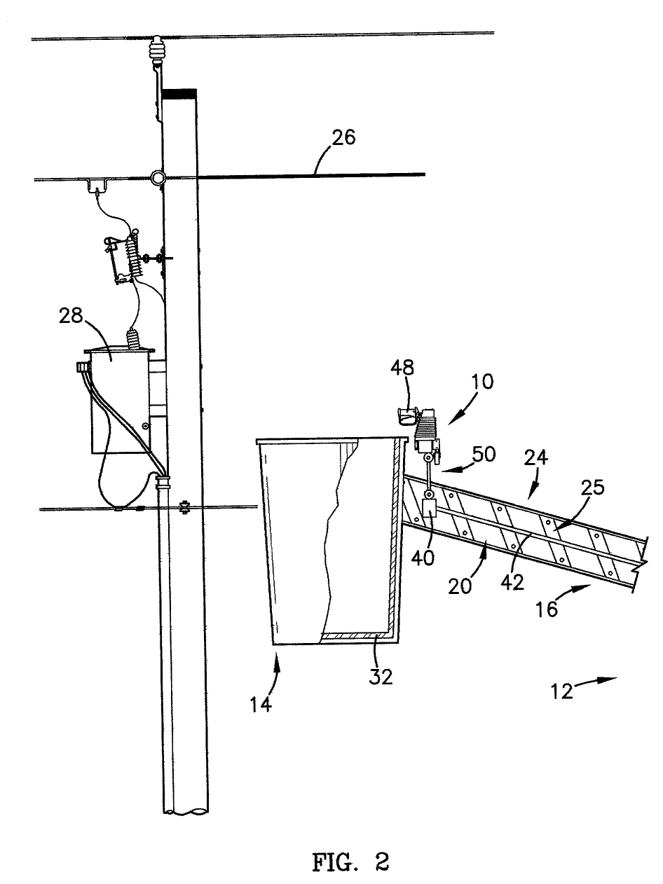

Referring to FIGS. 1 and 2, a control system 10 is shown constructed in accordance with a preferred first embodiment of the present invention. The control system 10 may be used on any boomed apparatus, such as, for example, an aerial lift device, digger derrick, of crane, having an electrically isolated work station 14. To facilitate disclosure of the present invention, the control system 10 is shown installed on an exemplary boomed apparatus, a common bucket truck 12, shown in FIG. 1. The control system 10 is operable to facilitate maintaining electrical isolation of the workstation 14 by transmitting an optical signal thereto, passively modulating, attenuating, or otherwise changing the optical signal to produce a changed optical signal corresponding to a control input from the work station 14, and transmitting the resulting changed optical signal for implementation.

Referring particularly to FIG. 1, the otherwise substantially conventional bucket truck 12 broadly comprises the work station 14; a movable boom 16; a plurality of electro-hydraulic control valves, actuators, pulsars, or similar devices 18; and a vehicular platform 20. The work station 14 is operable to lift or otherwise carry at least one worker to an elevated work site, and is coupled with the boom 16 at or near a distal end 24 thereof. As desired, the work station 14 may or may not include a protective, electrically insulating liner operable to substantially electrically isolate the worker located in the work station 14. A control station 26 is located in or on the work station 14 to allow the elevated worker to control movement of the boom 16. The boom 16 is hydraulically, mechanically, or otherwise movable so as to elevate or otherwise position the work station 14 where desired, and is coupled with the vehicular platform 20 at or near a base end 28 of the boom 16 which is opposite the distal end 24. A section 27 or portion of the boom 16 is constructed of an electrically non-conductive, or dielectric, material so as to provide a dielectric gap between the work station 14 and the potentially electrically grounded vehicular platform 20. The control valves 18 are located near the base end 28 of the boom 16, and are operable to implement movement of the boom 16 and positioning of the workstation 14 in a conventional manner and in accordance with control inputs provided by the worker via the control station 26. The vehicular platform 20 is motorized and wheeled or otherwise adapted to quickly and efficiently travel to and from the work site. During movement of the boom 16 at the work site, the vehicular platform 20 will either be in direct contact with an electrical ground, such as, for example, the Earth, or imminently at risk of direct or indirect contact therewith. Thus, it will be appreciated that control signals provided by the worker via the control station 26 located in or on the work station 14 must travel from the distal end 24 to the base end 28 of the boom 16 in order to implement the desired movement.

Referring also to FIG. 2, a preferred embodiment of the control system 10 broadly comprises an optical signal source 30; a first optical path 32; an electrically passive signal modulator 34 coupled with an electrically passive input mechanism 36; a second optical path 38; and an optical signal receiver 40.

The source 30 is a transmitter operable to generate an optical signal for transmission via the first path 32 to the modulator 34 at the work station 14. In a preferred embodiment, the source 30 is located at or near the base end 28 of the boom 16 or on the vehicular platform 20. Thus, the source 30 is located on a non-isolated or lower side 44 of a dielectric gap 46 provided by the non-conductive boom section 27.

The first path 32 is operable to transmit the optical signal from the source 30 to the modulator 34 across the dielectric gap 46. The first path 32 is an optical waveguide constructed of an electrically non-conducting or dielectric material, such as, for example, fiberoptic cable, that provides a secure low-loss transmission medium for optical signals. Because the first path 32 is constructed of a dielectric material, it can span the dielectric gap 46 without compromising electrical isolation of the work station 14.

The modulator 34 is operable to passively modulate, attenuate, or otherwise change the optical signal to produce a changed optical signal corresponding to a control input provided by the worker via the input mechanism 36. The modulator 34 and the input mechanism 36 are located on an electrically isolated or upper side 48 of the dielectric gap 46 and near, in, or on the work station 14.

Preferably, both the modulator 34 and the input mechanism 36 are electrically passive devices, meaning that there are, for example, no electrical contacts, circuit boards, electronic components, copper conductors, or power supplies associated with them. Thus, all components located on the isolated side 48 of the dielectric gap 46 may be constructed substantially entirely or materially of dielectric material, thereby further protecting against dangerous electrical discharges. The modulator 34 may be, for example, linear or rotational in nature. The input mechanism 36 may be, for example, a lever (for linear motion) or a dial (for rotational motion) with which the worker can provide the control input corresponding to the desired movement. Furthermore, the modulator 34 and the input mechanism 36 may be coupled together with a dielectric linkage, thereby further protecting against electrocution.

The second path 38 is operable to transmit the changed optical signal from the modulator 34 back across the dielectric gap 46 to the receiver 40. The second path 38 is otherwise substantially similar or identical to the first path 32. In one embodiment, the first and second paths 32, 38 may be the same path; in an alternative embodiment, the first and second paths 32, 38 may be substantially separate and distinct paths. Furthermore, the source 30 and receiver 40 may also be electrically isolated relative to one another, as necessary or desired.

The receiver 40 is operable to receive the changed optical signal for implementation. Preferably, the receiver 40 or a circuit associated therewith are also operable to convert the changed optical signal to a proportional electrical signal for actuating the control valves 18. This proportional electrical signal may be amplified and used directly, or may be input to a conventional control system, as desired.

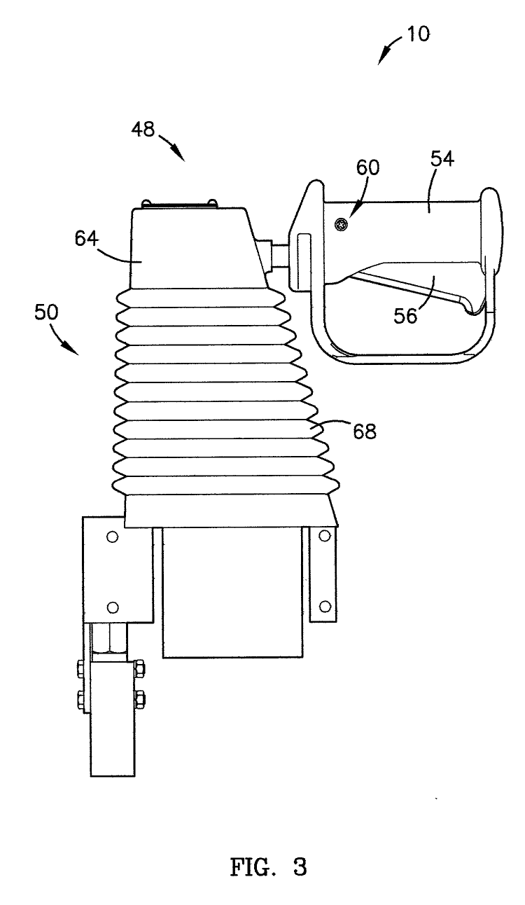

In operation, referring also to FIG. 3, the source 30, located at or near the base end 28 of the boom 16, generates the optical signal, as depicted in box 60, and transmits it via the first path 32 across the dielectric gap 46 provided by the non-conductive boom portion 27, as depicted in box 62. The optical signal is received at the modulator 34 which is located in or on the work station 14 on the isolated side 48 of the dielectric gap 46. The worker, desiring to move the boom 16 so as to reposition the work station 14, provides a control input using the electrically passive input mechanism 36, as depicted in box 64. The input mechanism 36 transmits the control input via a dielectric linkage to the modulator 34. The electrically passive modulator 34 modulates, attenuates, or otherwise changes the optical signal to produce a changed optical signal corresponding to the control input, as depicted in box 66. The changed optical signal is then transmitted via the second path 38 back across the dielectric gap 46, as depicted in box 68. The receiver 40 receives the changed optical signal, as depicted in box 70, and, in one embodiment, converts it to a proportional electrical signal, as depicted in box 72, which is then amplified and applied directly to the control valves 18 to implement the desired movement of the boom 16 or work station 14, as depicted in box 74.

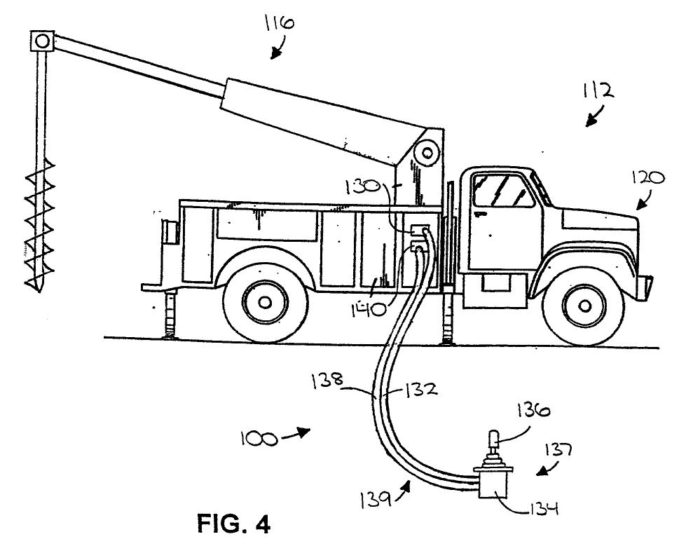

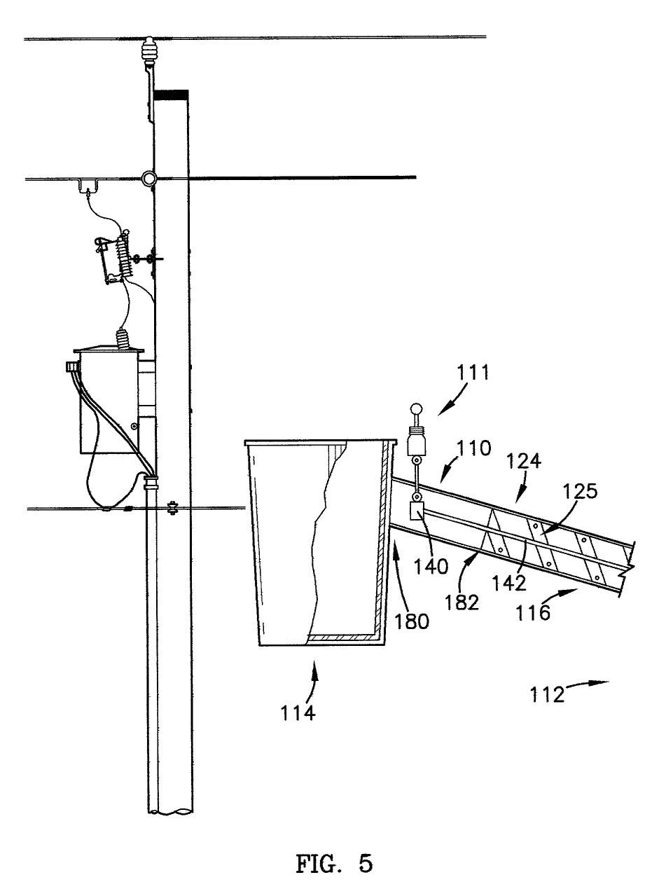

Referring to FIG. 4, a preferred second embodiment of the control system 100 is shown adapted for use and installed on a common digger derrick 112, wherein the worker is not limited to or located in a work station, but may instead be located on the ground, at or near the digger derrick's vehicular platform 120. The components of the control system 100, including the optical signal source 130; the first optical path 132; the electrically passive signal modulator 134 coupled with the electrically passive input mechanism 136; the second optical path 138; and the optical signal receiver 140, and their operations are substantially no different than was described above. In the second embodiment, however, the modulator 134 and the input mechanism 136 are provided in a substantially portable housing 137, and the first path 132 and the second path 138 take the form of or are included in a flexible tether 139 coupling the portable modulator 134 and input mechanism 136 to the source 130 and the receiver 140. Thus, the worker is able to move about and around the digger derrick 112, limited only by the length and flexibility of the tether 139, while providing control inputs for moving the boom 116.

It will be appreciated that the first embodiment, wherein the control system 10 is fixedly located on the boom apparatus, and the second embodiment, wherein the control system 100 is movable, may be provided together on a single boomed apparatus, thereby allowing for maximum flexibility with regard to the worker's location when providing the control inputs.

From the preceding description, it will be appreciated that the present invention provides substantial advantages over the prior art, including, for example, elimination of the overall complexity, weight, space-requirements, and electrical conductivity associated with using hydraulic valves, hoses, and fluid to transmit control signals from the work station down the boom. Furthermore, the control system overcomes much of the mechanical complexity, cost, weight, and space required to implement and physically and operationally support an upper control system at the distal end of the boom. Additionally, the control system is not susceptible to electromagnetic interference, such as may be encountered when working in close proximity to highly charged electrical lines, transformers, or other similar devices.

Although the invention has been described with reference to the preferred embodiment illustrated in the attached drawings, it is noted that equivalents may be employed and substitutions made herein without departing from the scope of the invention as recited in the claims. Thus, for example, though described herein as having only one optical signal, first and second paths, modulator, and input mechanism, the control system can be readily adapted to provide as many distinct changed optical signals as may be necessary or desired to transmit any number of control inputs corresponding to a variety of movements or functions associated with the aerial device. Those with skill in the art will appreciate that such adaptation may be achieved in a number of ways, including, for example, with completely redundant components, one set for each type of control input, or with some or all of the components being operable to facilitate multiple types of control inputs. In various possible embodiments, for example, a single source may transmit multiple signals via multiple first paths, or a single input mechanism may be differently actuatable so as to provide different types of control inputs.

Having thus described the preferred embodiment of the invention, what is claimed as new and desired to be protected by Letters Patent includes the following:

1. A control system for an apparatus having a movable boom, the control system comprising:
a signal source operable to generate an optical signal;
an input mechanism operable to provide a control input;
a modulator operable to receive the control input and the optical signal and to change the optical signal to produce a changed optical signal corresponding to the control input; and
a receiver operable to receive the changed optical signal for implementation,
wherein the input mechanism and the modulator are electrically isolated from the signal source and the receiver by a dielectric gap across which the optical signal and the changed optical signal are transmitted.

2. The control system as set forth in claim 1, wherein the input mechanism and the modulator are electrically passive devices.

3. The control system as set forth in claim 1, wherein the control system is mounted on a workstation coupled with the movable boom.

4. The control system as set forth in claim 1, wherein the input mechanism and the modulator are coupled with the signal source and the receiver by a flexible tether, and the flexible tether provides the dielectric gap.

5. A boomed apparatus comprising:
a movable boom having a base end and a distal end and a dielectric portion therebetween; and
a workstation coupled with the boom near the distal end, with the workstation being substantially electrically isolated from a remainder of the aerial device by the dielectric portion, and the work station including no electrically active components, wherein a control input may be provided by a worker located in the work station using an electrically passive mechanism to control movement of the boom by transmitting a signal across the dielectric portion.

6. The aerial device as set forth in claim 5, wherein the signal is an optical signal.

7. The aerial device as set forth in claim 6, wherein the optical signal is transmitted across the dielectric portion using a dielectric optical transmission medium.

8. A control system for an aerial device the control system comprising:
a signal source operable to generate an optical signal;
an electrically passive modulator operable to receive a control input and the optical signal and to change the optical signal in an electrically passive manner to produce a changed optical signal corresponding to the control input; and
a receiver operable to receive the changed optical signal for implementation.

9. The control system as set forth in claim 8, wherein the aerial device includes a workstation coupled with a moveable boom, wherein the workstation is electrically isolated from an electrical ground by a dielectric gap, and the signal source and the receiver are located on an electrically non-isolated side of the dielectric gap and the workstation and the modulator are located on an electrically isolated side of the dielectric gap.

10. The control system as set forth in claim 9, further including a first optical path extending between the signal source and the modulator and operable to transmit the optical signal therebetween and across the dielectric gap, wherein the first optical path is constructed of a dielectric material so as not to substantially affect the electrical isolation of the workstation.

11. The control system as set forth in claim 10, further including a second optical path extending between the modulator and the receiver and operable to transmit the changed optical signal therebetween and across the dielectric gap, wherein the second optical path is constructed of a dielectric material so as not to substantially affect the electrical isolation of the workstation.

12. The control system as set forth in claim 8, wherein the control input is provided to the modulator via an electrically passive input mechanism.

13. The control system as set forth in claim 8, further including a conversion circuit operable to convert the received changed optical control signal to a proportional electrical signal.

14. A control system for an aerial device having a workstation coupled with a moveable boom, wherein the workstation is electrically isolated from an electrical ground by a dielectric gap, the control system comprising:
a signal source located across the dielectric gap from the work station and operable to generate an optical signal;
a first optical path operable to transmit the optical signal across the dielectric gap;
an electrically passive input mechanism operable to provide a control input;
an electrically passive modulator operable to receive the control input and the optical signal and to change the optical signal in an electrically passive manner to produce a changed optical signal corresponding to the control input; and
a second optical path operable to transmit the changed optical signal back across the dielectric gap; and
a receiver operable to receive the changed optical signal for implementation.

15. The control system as set forth in claim 14, wherein the first optical path and the second optical path are both fiberoptic cables.

16. The control system as set forth in claim 14, further including a circuit operable to convert the received changed optical control signal to a proportional electrical signal.

17. A method of controlling an aerial device, the method comprising the steps of:
(a) generating an optical signal;
(b) receiving a control input;
(c) changing the optical signal in an electrically passive manner to produce a changed optical signal corresponding to the control input; and
(d) receiving the changed optical signal for implementation.

18. The method as set forth in claim 17, further comprising the step of (e) transmitting the optical signal across a dielectric gap prior to changing the optical signal.

19. The method as set forth in claim 17, further comprising the step of (e) transmitting the changed optical signal across a dielectric gap after changing the optical signal.

20. The method as set forth in claim 17, further comprising the step of (e) converting the changed optical signal to a proportional electrical signal after receiving the changed optical signal.

21. A method of controlling an aerial device, the method comprising the steps of:
(a) generating an optical signal;
(b) transmitting the optical signal across a dielectric gap;
(c) receiving a control input from an electrically passive input mechanism;
(d) changing the optical signal in an electrically passive manner to produce a changed optical signal corresponding to the control input;
(e) transmitting the changed optical signal back across the dielectric gap;
(f) receiving the changed optical signal for implementation; and
(g) converting the changed optical signal to a proportional electrical signal.
